(19) United States
(12) Patent Application Publication
(10) Pub. No.: US 2020/0271528 A1
(43) Pub. Date: Aug. 27, 2020

(54) METHOD FOR PRODUCING A SENSOR AND SENSOR

(71) Applicant: Heraeus Sensor Technology GmbH, Hanau (DE)

(72) Inventors: Karlheinz WIENAND, Aschaffenburg (DE); Stefan DIETMANN, Alzenau (DE); Matsvei ZINKEVICH, Goldbach (DE); Ralf MOOS, Bayreuth (DE); Michael SCHUBERT, Bayreuth (DE); Martin TURWITT, Bruckköbel (DE)

(73) Assignee: Heraeus Sensor Technology GmbH, Hanau (DE)

(21) Appl. No.: 16/339,912

(22) PCT Filed: Oct. 11, 2017
(86) PCT No.: PCT/EP2017/075982

§ 371 Date: May 13, 2020

(30) Foreign Application Priority Data
Oct. 11, 2016 (DE) 10 2016 119 340.2

(51) Int. Cl. G01K 7/18; G01F 1/69

(52) U.S. Cl. CPC G01K 7/183; G01F 1/69

(57) ABSTRACT

One aspect relates to a method for producing a sensor, in particular a temperature sensor, with at least one electrically conductive layer and at least one additional layer, in particular a passivation layer and/or an insulation layer. According to one aspect, the electrically conductive layer and/or the additional layer, in particular the passivation layer and/or the insulation layer, are produced by aerosol deposition (aerosol deposition method, ADM).

The invention relates to a method for producing a sensor, in particular a temperature sensor, comprising at least one electrically conductive layer and at least one additional layer, in particular a passivation layer and/or an insulation layer. The invention also relates to a sensor, in particular a temperature sensor, comprising at least one electrically conductive layer and at least one additional layer, in particular a passivation layer and/or an insulation layer, wherein the sensor is preferably produced by means of a method according to the invention. In addition, the invention relates to the use of a sensor according to the invention in a vehicle.

It is known to provide passivation layers in temperature sensors to prevent toxic contamination. For example, passivation coatings are applied on platinum structures of temperature-sensitive resistors. Passivation layers are applied, for example, using PVD or thick-film processes. Passivation layers applied in this way are not completely leak-proof, however.

In a PVD method the passivation material, in particular aluminium oxide material (Al₂O₃) is converted into the gas phase and condenses as a film on the surface of the sensor. In addition to the stem growth which occurs in this method, the phase status of the material deposited by evaporation is a disadvantage.

The aluminium oxide used, for example, is present in the gamma phase, which under temperature exposure converts into the stable alpha phase. Such a phase transformation can be associated with a volume shrinkage of up to approx. 8%. Such a volume shrinkage leads to cracks in the applied passivation layer.

Application by means of sputtering processes, in which the passivation material, in particular the aluminium oxide, is removed in the plasma using ion bombardment of a target, also shows the described disadvantages.

In a thick-film process, a paste with passivation material, in particular a paste with aluminium oxide particles, is printed on the surface by screen printing methods. After driving out the organic matter, the aluminium oxide particles are sintered at temperatures of 1000° C.-1500° C., and even when different particle diameters are combined to achieve a high packing density, they still contain cavities and defects.

In order to seal the passivation layers produced by the methods described, it is known to additionally apply further layers, consisting of glass, for example. Temperature-resistant glasses have a very high silicon dioxide (SiO₂) content however, which under a reducing atmosphere that may be present, is reduced to silicon. If silicon is able to diffuse through pores and cracks to the electrically conductive layer, in particular to the platinum layer, this leads to contamination of the electrically conductive layer. Furthermore, a platinum silicide formation may occur, which can lead to destruction of the electrically conductive layer, in particular the platinum structure.

The object of the invention is to specify a further developed method for producing a sensor, in particular a temperature sensor, by means of which hermetically sealed sensor layers can be produced.

A further object of the present invention is to specify a further developed sensor with at least one hermetically sealed layer, in particular at least one electrically conductive layer and/or at least one additional layer, in particular a passivation layer and/or insulation layer, which is designed hermetically sealed.

It is also the object of the present invention to specify a suitable possible application of the sensor according to the invention.

In accordance with the invention this object is achieved in relation to a method for producing a sensor, in particular a temperature sensor, by the features of Claim 1. In regard to a sensor, in particular a temperature sensor, comprising at least one electrically conductive layer and at least one other layer, in particular a passivation layer and/or an insulation layer, the object is achieved by the features of Claim 7. In regard to a usage of a sensor according to the invention, the object is achieved by the features of Claim 18.

The invention is based on the idea of specifying a method for producing a sensor, in particular a temperature sensor, comprising at least one electrically conductive layer and at least one other layer, in particular a passivation layer and/or an insulation layer, wherein the electrically conductive layer and/or the additional layer, in particular the passivation layer and/or the insulation layer, are produced using the aerosol deposition method [ADM].

The ADM method is a cold coating method, in which a suitable powder is transformed into an aerosol. In a coating chamber and an aerosol generator, a crude vacuum is generated in the range of 1 to 50 mbar. The resulting pressure difference from the addition of a process gas into the aerosol generator transports the aerosol to a nozzle, in which it is accelerated to several 100 m/s and then deposited on a substrate. In addition to a plastic deformation, this also results in a breakdown of the powder particles into nm-size fragments, which arrange themselves to form a dense and well adhering layer.

In other words, the method according to the invention is based on the fact that at least one layer of the sensor is produced by means of aerosol deposition.

The method according to the invention can have the following steps:
a) Provision of a sensor carrier;
b) Direct or indirect application of the at least one electrically conductive layer on the sensor carrier;
c) Application of the at least one additional layer, in particular the passivation layer and/or the insulation layer, by means of aerosol deposition.

It is possible that the electrically conductive layer, which in particular comprises platinum, is deposited directly on the sensor carrier.

It is also possible that at least one intermediate layer is formed between the sensor carrier and the electrically conductive layer. The electrically conductive layer is therefore applied to the at least one intermediate layer following the deposition of this at least one intermediate layer.

The sensor carrier can be made out of ceramic and/or metal and/or a metal alloy and/or glass and/or glass-ceramic and/or plastic. In particular, the sensor carrier is composed of insulating oxides, such as pure aluminium oxide (Al₂O₃), or with aluminium oxide mixed with additives and/or various zirconium oxide ceramics or zirconium mixed oxide ceramics and/or various magnesium oxide (MgO) compounds and/or silicon oxide (SiO₂).

The coefficient of thermal expansion of the sensor carrier is preferably in the range of 0.05·10⁻⁶ K⁻¹ to 15·10⁻⁶ K⁻¹.

It is also advantageous if the specific electrical resistance of the sensor carrier at 600° C. is greater than 10¹⁰ Ωcm.

In a further embodiment of the invention, the sensor carrier can be designed to be electrically conductive.

It is possible that the intermediate layer is also applied to the sensor carrier using aerosol deposition (aerosol deposition method). In aerosol deposition (ADM), in particular in step c), a powder consisting of
a) aluminium oxide (Al₂O₃) with a purity of the base materials of at least 94 wt %.
and/or
b) magnesium oxide (MgO) with a purity of the base materials of at least 94 wt %.
and/or
c) magnesium titanate in the compositions Mg₂TiO₅, MgTiO₃, or MgT₂O₅, with a total purity of the base materials of at least 98 wt %.
and/or
d) binary zirconia alloys (ZrO₂) with the stabilizers yttrium oxide, in particular 0 wt. % to 20 wt. % yttrium oxide, and/or CaO, in particular 0 wt. % to 15 wt. % CaO, and/or MgO, in particular 0 wt. % to 15 wt. % MgO, with a total purity of the base materials of at least 98 wt %.
and/or
e) ternary zirconia alloys (ZrO₂) in accordance with d) with additional additives of Nb₂O₅, in particular 0 wt.-% to 30 wt. % Nb₂O₅, and/or Ta₂O₅, in particular 0 wt. % to 30 wt. % Ta₂O₅, with a total purity of the base materials of at least 98 wt %.
   is preferably used.

The base materials can be mixed in any proportion.

Due to the purity of the powder used, a particularly hermetically sealed layer can be produced with no foreign materials being embedded, which in a later process could give rise to contamination of the sensor, in particular of the electrically conductive layer.

In the aerosol deposition method (ADM), in particular in step (c), an inert gas is used as a carrier gas, in particular helium (He) and/or argon (Ar) and/or nitrogen (N₂) and/or oxygen (O₂).

In addition, a temperature of not more than 150° C. is preferably applied during the aerosol deposition. This is the reason why the present method according to the invention is known as a cold coating process.

The aerosol deposition is preferably carried out in a coating chamber. In particular, during the aerosol deposition a vacuum is produced in the coating chamber. The aerosol deposition therefore takes place in the coating chamber under vacuum.

In the production according to the invention of an electrically conductive layer and/or additional layer, in particular a passivation layer and/or an insulation layer, the carrier gas is first introduced into a generator in which the coating powder is converted into an aerosol, which is to say the coating powder is finely dispersed in a carrier gas stream. The coating powder in particular contains insulating materials, preferably oxides, particularly preferably aluminium oxide.

By means of a nozzle the aerosol is sprayed into a coating chamber under vacuum conditions and onto the surface to be coated. The surface to be coated, in particular, the sensor carrier, is moved with an XY table.

Alternatively or additionally, it is possible that the nozzle is moved over the surface to be coated. A combination of the two, i.e. a movement of the table and the nozzle in the X-Y direction towards each other is also possible.

As a result of the kinetic energy of the coating particles, in particular of the aluminium oxide particles, on striking the surface to be coated these will become deformed and compressed. The resulting layer is extremely dense and free of cracks.

To produce a thicker layer, multiple “passes” can also be made.

It should be noted that the above described embodiment of the aerosol coating is only to be considered as an example. Possible variations of the aerosol coating are, for example, that the nozzle is moved or that the spraying is effected by several nozzles positioned one after the other.

For the direct production of a structure of the layer produced by ADM on the surface to be coated, a mask can be applied, for example before the coating. One option here is the use of “shadow masks”, which are located above the surface to be coated and have “openings” only at the places to be coated.

Also, desired structures can also be created by means of a special nozzle geometry and/or by the movement of the nozzle and/or the table in the X-Y direction during the deposition.

Defined structures can also be created by switching the nozzle jet on and off.

Another option also exists to implement the structuring of an ADM layer deposited over a whole surface using Lift-Off technology. This involves structuring a photo-resist layer by means of light or electron beam on the surface to be coated. Then, the surface is coated over the whole surface using ADM, and by dissolving away the photo-resist the overlaid ADM layer is removed.

ADM is a cold coating process. Since the coating particles, in particular the aluminium oxide particles are already in the alpha-phase, no phase change will take place under the application of high temperature. Therefore, leakage sites in the generated layer due to cracks and pores are avoided.

It is possible either for the at least one electrically conductive coating to be structured, and/or applied indirectly or directly on the sensor carrier in a structured form. Structuring or structured form is not defined as simply meaning a form of the electrically conductive layer which is implemented without gaps or without recesses. Instead, a structured electrically conductive coating can have, for example, a meandering shape. Other forms with recesses and/or trenches and/or openings are also conceivable.

For example, using a printing process, an electrically conductive coating can be directly or indirectly applied to a sensor carrier in a structured form. It is also possible that firstly a continuous smooth layer is applied directly or indirectly to the sensor carrier and that trenches and/or recesses and/or openings are introduced into the layer in a further step.

The electrically conductive layer can be structured, for example, using photolithographic techniques and/or by laser.

In a further embodiment of the invention, it is possible that after the application of at least one other layer, in particular the passivation layer and/or the insulation layer, the final arrangement is split into separate pieces. It is therefore possible to first produce a plurality of sensors, in particular, a plurality of temperature sensors, as a combined structure and then to separate them.

A further secondary aspect of the invention relates to a sensor, in particular a temperature sensor, comprising at least one electrically conductive layer and at least one additional layer, in particular a passivation layer and/or an insulation layer. The sensor according to the invention is particularly preferably produced according to a method according to the invention.

The sensor according to the invention, in particular the temperature sensor according to the invention, is based on the idea that at least one layer, namely the electrically conductive layer and/or the additional layer, in particular the passivation layer and/or the insulation layer, is produced using the aerosol deposition (aerosol deposition method). A layer of a sensor produced in such a way is applied as part of a cold coating process. The applied layer is a hermetically sealed layer.

At least one layer of the sensor produced using aerosol deposition comprises aluminium oxide (Al₂O₃) and/or magnesium oxide (MgO) and/or
a) aluminium oxide (Al₂O₃) with a purity of the base materials of at least 94 wt %.
and/or
b) magnesium oxide (MgO) with a purity of the base materials of at least 94 wt %.
and/or
c) magnesium titanate in the compositions Mg₂TiO₅, MgTiO₃, or MgTi₂O₅ with a total purity of the base materials of at least 98 wt %. and/or
d) binary zirconia alloys (ZrO₂) with the stabilizers yttrium oxide, in particular 0 wt. % to 20 wt. % yttrium oxide, and/or CaO, and in particular 0 wt. % to 15 wt. % CaO, and/or MgO, in particular 0 wt. % to 15 wt. % MgO, with a total purity of the base materials of at least 98 wt %.
and/or
e) ternary alloys (zirconia ZrO₂) as specified in d) with further additives formed of Nb₂O₅, in particular 0 wt. % to 30 wt. % Nb₂O, and/or Ta₂O₅, in particular 0 wt.-% to 30 wt. % Ta₂O₅, with a total purity of the base materials of at least 98 wt %.

In a particularly preferred embodiment of the invention, the layer produced using aerosol deposition (ADM) is a passivation layer of an insulating oxide, aluminium oxide being particularly preferred.

It is also advantageous if at least one layer produced using aerosol deposition (ADM) consists of up to at least 95% aluminium oxide (Al₂O₃).

For determining the crystalline phase of a deposited Al₂O₃ layer the method of X-ray diffraction is preferably used. An X-ray diffractometer of type Stadi P from the manufacturer Stoe & Cie GmbH is used for this purpose. For quantification of the phases the Rietveld method is applied. Alternatively, it is possible to produce defined mixtures of the required components for comparison and analysis.

The purity of the powder, in particular of the aluminium oxide powder, is determined using emission spectrometry. For the measurement ICP spectrometers of type iCAP 6500 duo or iCAP 7400 duo supplied by Thermo Fisher Scientific are used.

The measurements are carried out in accordance with the DIN EN ISO 11885 standard. In the case of aluminium oxide (Al₂O₃) powders, 100 mg of the sample is added to 8 ml of hydrogen chloride (HCl), 2 ml of nitric acid (HNO₃) and 1.5 ml of hydrogen fluoride (HF), and solubilized using a microwave pressure digestion process. The dissolved sample is then transferred to a test tube and refilled with purified water. The measurement solution is pumped into the measuring device, where it is nebulized, wherein the aerosol is introduced into an argon plasma. There, the components of the sample are evaporated, atomized, excited and partly ionized. The light emitted as the atoms and ions return to the base state is then detected. The wavelengths of the emitted light are characteristic of the respective elements contained in the sample. The intensity of the wavelengths is proportional to the concentration of the respective element.

Preferably, the specific electrical resistance in an Al₂O₃ layer produced using the aerosol deposition at a temperature of 600° C. is at least 10¹⁰ Ωcm.

The specific electrical resistance (RS) of the layer produced using aerosol deposition (ADM), in particular the aluminium oxide layer, is preferably determined with a 4-point measurement or a 2-point measurement according to the ASTM D257-07 standard. This requires first of all preparing a substrate, e.g. glass, for example with a size of 20 mm×60 mm. The layer to be examined, in particular the aluminium oxide material, is deposited onto the substrate. Each of the ends are metallized or imprinted with flat metal strips. The metal strips are arranged parallel to each other at intervals of 10 mm. A power source is connected to the two contacts and a current value is set.

In the case of the 4-point measurement, using two probes and a potentiometer (Hewlett-Packard 4355A) the potential drop between the metal strips is measured and the surface resistance (SR) is determined. The layer thickness (d) is determined from a layer produced in parallel. The specific electrical resistance (RS) is given by the following relation: RS=SR×d.

In addition, at least one layer produced using aerosol deposition can have a thickness of 100 nm-50 μm. To determine the layer thickness, a mechanical Perthometer (stylus instrument) is preferably used. This requires first of all preparing a glass substrate, for example with a size of 20 mm×60 mm. A part of the substrate surface is masked, e.g. with a metal foil clamped thereon. The layer to be examined is deposited on the substrate. After removal of the mask, the slice thickness is measured by passing the stylus of a mechanical Perthometer (Tencor 500, resolution <1 nm) over the layer step.

Preferably, the at least one layer produced using aerosol deposition is moisture tight. The sealing of the layer produced using aerosol deposition against moisture ingress is defined according to the DIN EN 60749-8: 2003-12 standard. Under this process a Pt200 resistance sensor (HDA 420) is coated with the layer to be tested and then immersed in a water bath at room temperature for at least 15 minutes. After removal and drying at room temperature, the resistance of the sensor is measured. For layers with adequate moisture tightness the resistance at +25° C. must not change by more than 1% of the initial value.

Furthermore, the sensor according to the invention can be characterized in that, after a minimum of two hours of temperature treatment at more than 1200° C. and subsequent cooling to 25° C., the layer produced using aerosol deposition has less than one crack per square centimetre.

Preferably, the layer produced by means of aerosol deposition has a coefficient of thermal expansion in the range of 4·10⁻⁶ K⁻¹ to 14·10⁻⁶ K⁻¹. The thermal expansion coefficient can be measured, for example, using dilatometry.

The layer produced by means of aerosol deposition preferably has a porosity of less than 1%. The porosity of a layer produced by aerosol deposition can be measured, for example, using mercury porosimetry. For performing a mercury porosimetry, devices supplied by the Porotec company are preferably used (Pascal 140 in the low-pressure range, Pascal 440 in the high-pressure range). The standard DIN 66133 defines the pore volume distribution and the specific surface area of solids by mercury intrusion. Preferably, the layer concerned is heated to 200° C. for approximately one hour before the measurement.

The layer produced by means of aerosol deposition preferably has a higher hardness than conventionally produced layers. Thus, for example, the hardness of an Al₂O₃ (>99.9%) layer produced by the ADM method is 10 GPa. The hardness of the layers produced with the PVD method and screen printing method (in both cases also pure Al₂O₃) is 4.7 GPa and 2.8 GPa respectively.

The hardness of a layer produced by aerosol deposition can be measured, for example, using nanoindentation. The Nano-Test platform monitors the motion of a diamond in contact with the sample. A change in current through a coil results in a compressive force being applied (electromagnetic force actuator principle) and causes a change in the position of the diamond. During the hardness measurement, the diamond tip continuously penetrates the sample. Via the change in capacitance of a capacitor, this distance change is then recorded as a function of the load. Consequently, by accurate calibration of the coil current applied and by measurement of the distance change, both the penetration depth and the applied load can be determined. To analyse the load versus penetration-depth curve the method proposed by Oliver & Pharr is normally used.

The layer produced by aerosol deposition can be a dielectric with a permittivity, or an insulator. It is also possible that an electron conductor is formed as the layer produced by aerosol deposition. The layer can also be a functional layer.

The sensor according to the invention also comprises a sensor carrier, which can consist of ceramic and/or metal and/or a metal alloy and/or glass and/or a glass ceramic and/or plastic. In a particular preferred form, the sensor carrier comprises aluminium oxide and/or magnesium oxide and/or zirconium oxide (zirconia), which can also be stabilized, and/or silicon oxide. The coefficient of thermal expansion of the sensor carrier is preferably 0.05·10⁻⁶ K⁻¹ to 15·10⁻⁶ K⁻¹.

The specific electrical resistance of the sensor carrier or the material of the sensor carrier at 600° C. is at least 10¹⁰ Ωcm. As regards the determination of the specific electrical resistance, the measurement already described according to the ASTM D257-07 standard can be applied.

It is possible for the sensor carrier to be designed electrically conductive.

The electrically conductive coating of the sensor is preferably formed of metal, in particular of platinum (Pt) and/or rhodium (Rh) and/or iridium (Ir) and/or palladium (Pd) and/or gold (Au) and/or tungsten (W) and/or tantalum (Ta) and/or nickel (Ni) and/or copper (Cu) and/or from an alloy of the specified metals.

Alternatively, it is possible that the at least one electrically conductive layer is produced from a conductive ceramic, such as silicon carbide (SiC). It is also possible for the electrically conductive coating to comprise a conductive ceramic.

It is also possible for the electrically conductive layer to be made of a material from the group of precious metals and/or nickel (Ni) and/or chromium (Cr) and/or nickel-chromium (NiCr) and/or silicon nitride (Si₃N₄) or alloys of the specified elements.

The at least one electrically conductive layer can be structured. It is possible that the electrically conductive layer comprises a structuring in the form of lines and/or conductor loops and/or meandering structures and/or inter-digital structures and/or networks and/or pads.

The structure of the electrically conductive layer can, as previously described, be introduced into the electrically conductive coating retrospectively as part of the method according to the invention. It is also possible to apply the electrically conductive layer directly or indirectly on the sensor carrier already in a structured form.

The electrically conductive coating is covered, at least in some sections, by at least one functional layer, in particular a protective layer and/or sensor layer and/or insulation layer and/or barrier layer. The electrically conductive coating is preferably covered, at least in some sections, by a layer produced using aerosol deposition.

The at least one intermediate layer arranged between the sensor carrier and the electrically conductive layer can be, for example, a balancing layer for smoothing purposes, or an adhesive layer or a layer for the purpose of mechanical decoupling, or a layer for electrical insulation, or a layer for preventing cracking in the electrically conductive layer. It is possible for a plurality of intermediate layers to be formed between the sensor carrier and the at least one electrically conductive layer.

In one embodiment of the invention it is possible that at least two electrically conductive layers are formed, wherein at least one layer produced by aerosol deposition can be formed between the at least two electrically conductive layers.

It is possible that at least one electrically conductive structure is applied alternately with at least one layer produced by aerosol deposition. The topmost electrically conductive layer can be at least partially exposed, i.e. at least in some sections not covered with an additional layer.

If the sensor has at least two electrically conductive layers, it is possible that the electrically conductive layers are connected to each other by at least one measuring bridge.

Furthermore, the electrically conductive structures can be insulated from each other, either completely or at least in some sections. The insulation can be provided, for example, by means of a layer produced using aerosol deposition.

At least one electrically conductive layer can be used for heating and/or measuring. It is also possible that at least one electrically conductive layer can be used for measuring parameters such as the electrical conductivity and/or the electrical resistance and/or the impedance and/or the voltage and/or the current amplitude and/or the frequency and/or the capacitance and/or the phase offset.

A further secondary aspect of the invention relates to the use of a sensor according to the invention in a vehicle for measuring temperature and/or particle quantities and/or soot particle quantities and/or reaction heat and/or a gas content and/or a gas flow. Similar advantages are obtained, as have already been presented with the method according to the invention and/or in connection with the sensor according to the invention.

Hereafter, the invention is described in greater detail with reference to the appended schematic drawings. They show:

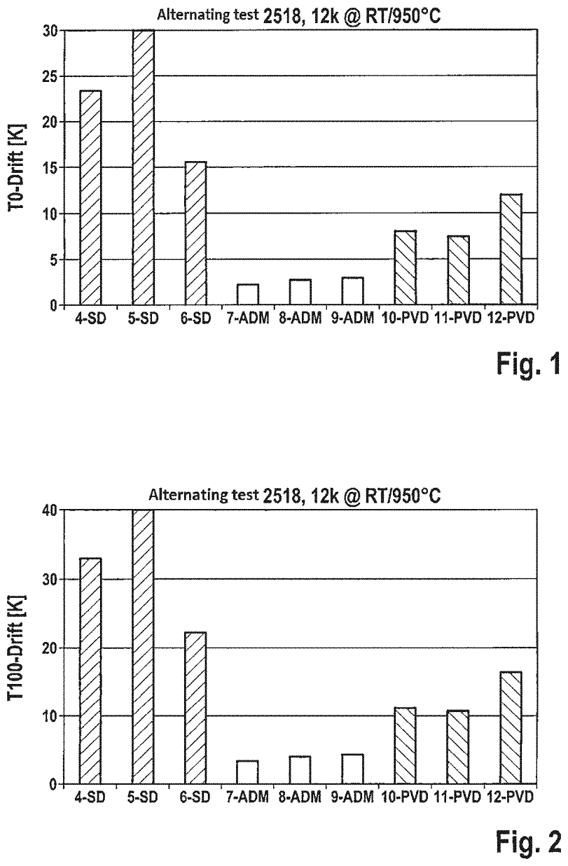

FIG. 1-3 Results of comparative temperature drift measurements on a sensor according to the invention in comparison to known sensors;

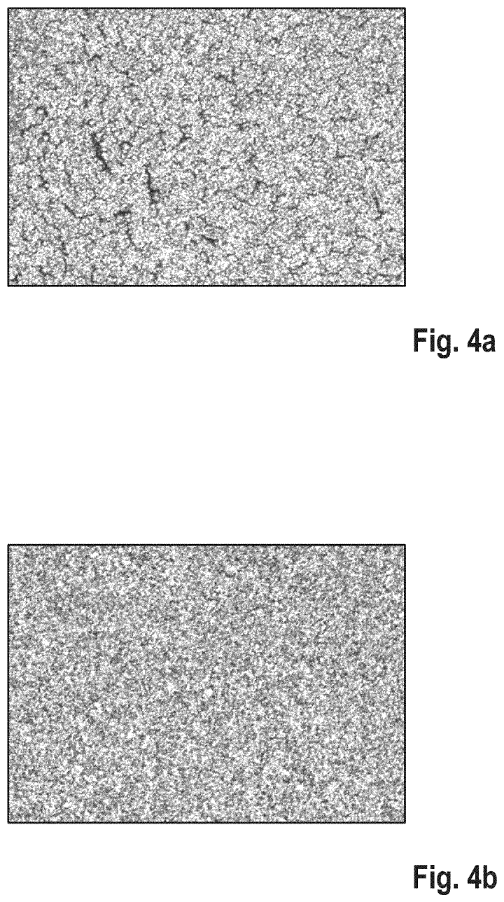

FIG. 4a+4b plan views of Al₂O₃ layers, wherein the Al₂O₃ layer of FIG. 4a is produced using a PVD process and the Al₂O₃ layer of FIG. 4b by ADM;

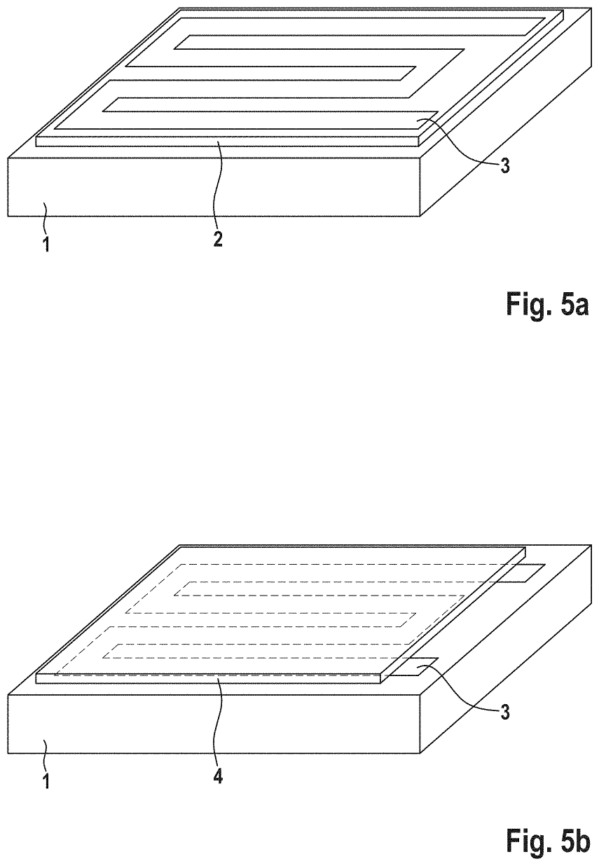

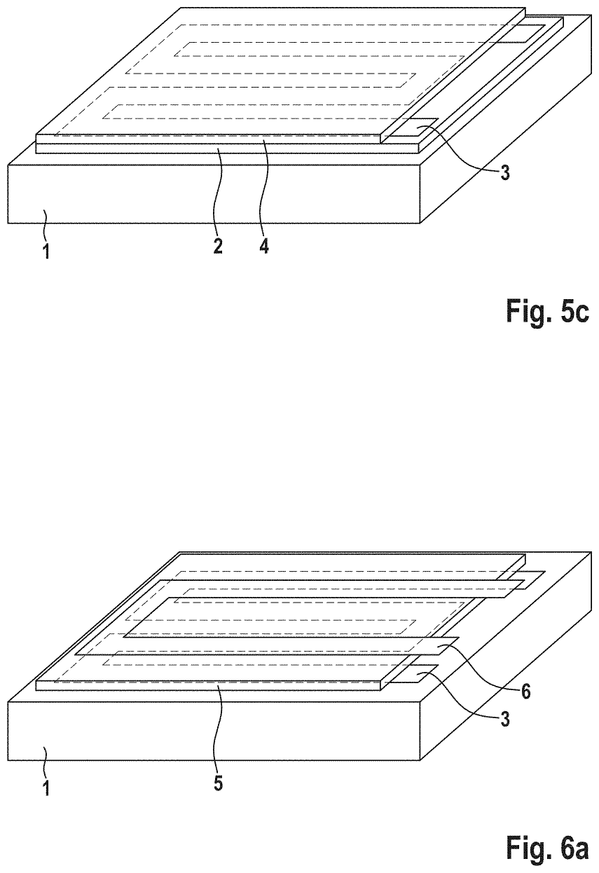

FIGS. 5a-5c differently designed sensors;

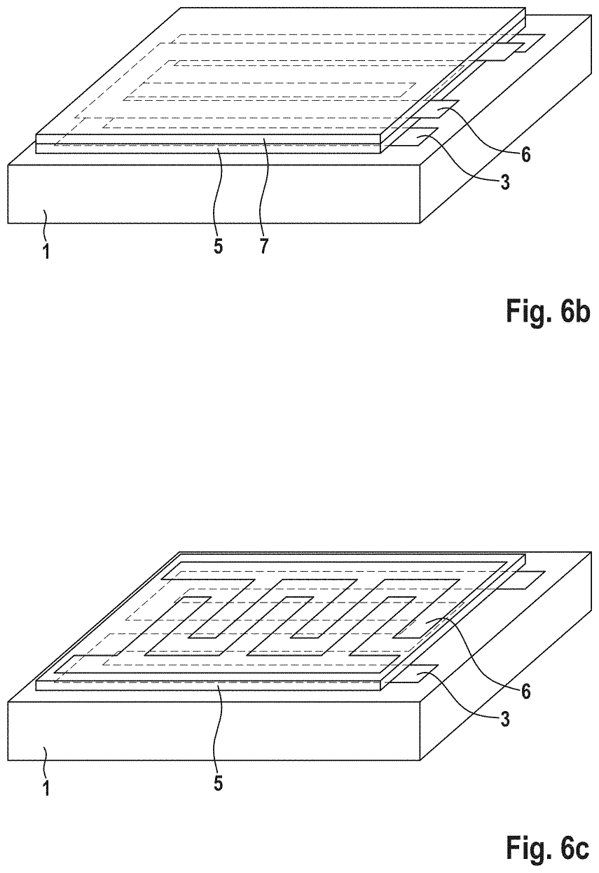

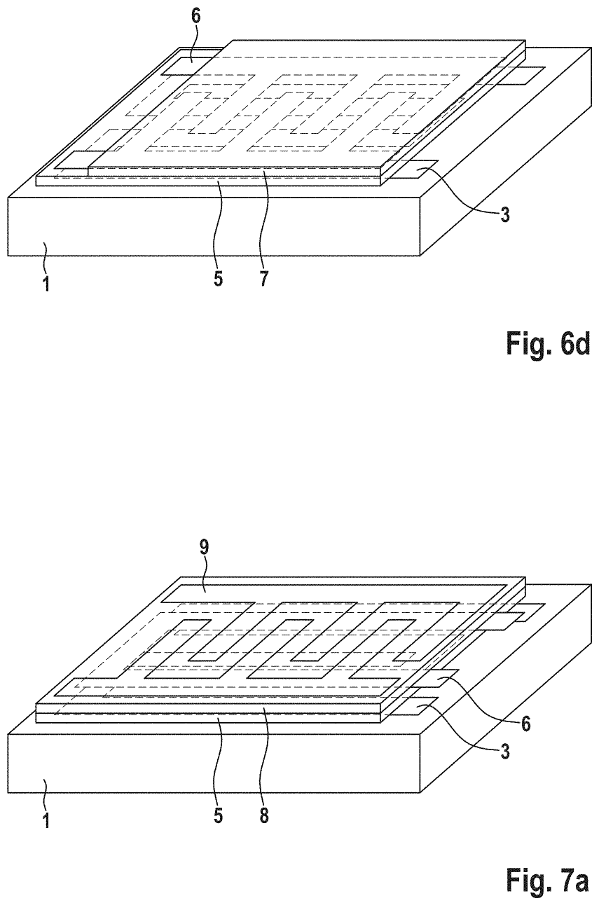

FIGS. 6a-6d differently designed sensors with insulation and covering layer; and

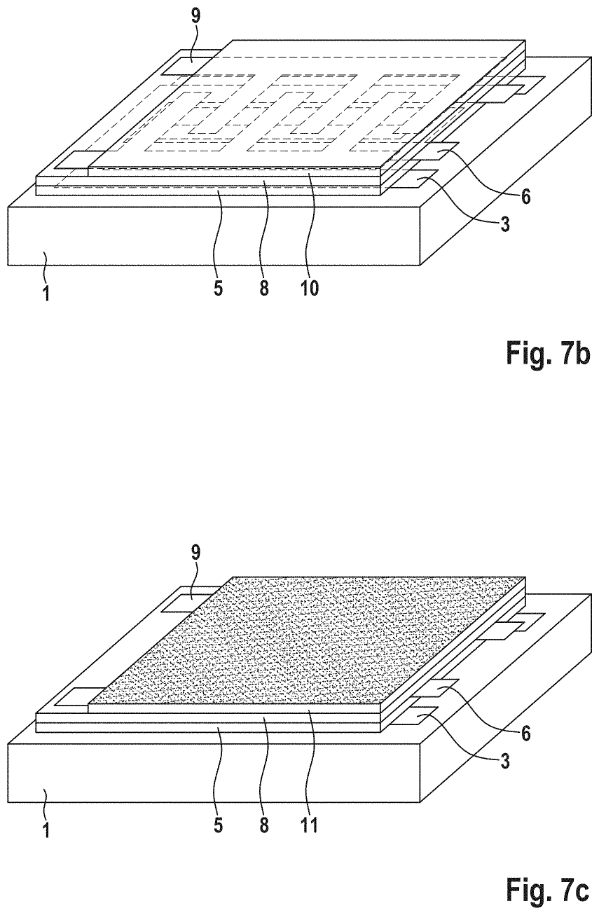

FIGS. 7a-7c differently designed sensors with a plurality of insulation layers and/or covering layers.

FIGS. 1-3 show the extent to which the temperature drift of a sensor according to the invention can be positively influenced in comparison to known sensors that are produced using standard methods.

The sensor according to the invention comprises an electrically conductive layer of platinum and a passivation layer of aluminium oxide (Al₂O₃). The aluminium oxide layer is produced by means of aerosol deposition.

FIGS. 1-3 show a comparison with respect to differently applied Al₂O₃ passivation layers. The first three bars each relate to sensors that have an Al₂O₃ layer applied using a screen printing method.

The bars 4-6 on the other hand relate to Al₂O₃ layers applied by means of aerosol deposition (ADM).

Bars 7-9 by contrast relate to Al₂O₃ layers applied to a platinum structure using PVD (Physical Vapor Deposition) methods.

The design of the sensors, i.e. the platinum layers, the layer thickness and dimensions, were identical. Temperature-change tests were carried out with the finished sensors. To that end, the sensors were placed into a chamber furnace using an apparatus and then removed from the chamber furnace again. As soon as the sensors were outside the chamber furnace they were also blown with air, so that a rapid cooling was obtained.

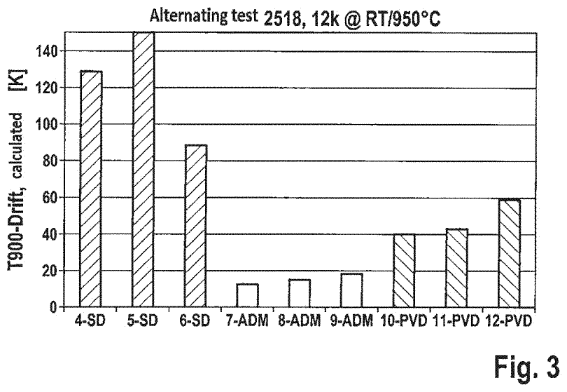

The graphic of FIG. 1 shows the temperature drift in Kelvin after 12,000 cycles at 0° C. The graphic in FIG. 2 shows the temperature drift in Kelvin after 12,000 cycles measured at 100° C. The graphic in FIG. 3 shows the temperature drift in Kelvin after 12,000 cycles measured at 900° C.

It is clear to see that at all the temperatures, i.e. at 0° C. and at 100° C. and at 900° C., the sensors that have a passivation layer of Al₂O₃ which was applied using aerosol deposition (ADM) show a significantly lower drift.

These test results confirm that passivation layers produced using aerosol deposition (ADM), in particular Al₂O₃ layers, significantly improve a sensor, the requirements regarding the stability being exceeded by several times.

The following table lists a comparison of the electrical resistances of the insulation layers produced in different ways. To produce this models were assembled in which the Al₂O₃ insulation layer was applied between two platinum electrode areas, firstly by means of aerosol deposition and secondly by screen printing methods. The thickness of the layers was 9 microns in each case.

| | Insulation | Insulation |
|---|---|---|
| | resistance | resistance |
| | In GOhm at room | In GOhm |
| Al₂O₃ using | temperature | at 250° C. |
| 1) ADM method | 7.0 + 3.08 | 25.7 ± 3.95 |
| 2) Screen-printing method | 0.4 ± 0.16 | 2.1 ± 0.34 |

It is found that at room temperature, the layer produced using aerosol deposition has an electrical insulation resistance 17 times higher than the layer produced by screen printing, i.e. the ADM layer insulates substantially better.

At 250° C., the layer produced by aerosol deposition (ADM) has a 12× higher value of insulation resistance compared to a screen-printed layer.

FIG. 4a shows an Al₂O₃ layer which is produced conventionally using a PVD process. Cracks are visible. These arise after the temperature treatment due to shrinkage caused by the phase transformation from gamma to alpha.

FIG. 4b shows an Al₂O₃ layer which is produced by ADM. The Al₂O₃ powder exists as o-phase during the production of the layer. Since ADM is a cold coating method, no phase transformation takes place. No cracks are produced during the temperature treatment.

Due to the low porosity, the absence of cracks and low levels of defects, a very dense ADM layer is obtained that has both a high electrical insulation resistance with a good thermal heat conductivity.

Due to the positive properties described, such as the high electrical insulation resistance combined with good thermal conductivity, layers produced by ADM are particularly well suited for constructing multi-layer systems, in which ADM layers alternating with conductive layers or structures are used for constructing sensors.

FIG. 5a shows a simple sensor design. An ADM layer 2 is applied to a substrate carrier 1. Due to the very good insulation resistance, the ADM layer 2 acts as an insulating layer if metals or oxides, such as stabilized zirconium oxide, with low electrical resistance are used as the substrate carrier material.

This design is also applied as a balancing layer when the substrate carriers 1 has a rough, topographical, porous or defective surface, or if defects such as cracks or small holes are present in the surface. Proven materials for forming this ADM layer, as described above, are oxides or mixed oxides, preferably Al₂O₃ or MgO. On the insulation layer 2 at least one conductive structure or surface 3 is applied, which preferably consists of platinum, gold, nickel or a CrNi alloy.

The insulation layer 2 can also be used to influence the adhesion of the conductive surface or structure 3.

FIG. 5b shows a structure in which at least one conductive layer or structure 3 is applied to a substrate carrier 1. Proven materials for use as the substrate carrier material are Al₂O₃ or stabilised ZrO₂. The conductive layer or structure 3 preferably consists of platinum, gold, nickel or a CrNi alloy.

The conductive layer or structure 3 is covered by an ADM layer 4. Al₂O₃ is a proven material for use as the coating material. The ADM layer 4 acts as a protection or passivation layer, because layers thus produced are very dense and have a low gas permeability. Non-covered areas of the conductive layer or structure 3 are used here as a connection surface for electrical contacting. This structure would be used as a temperature resistor or heating resistor.

FIG. 5c shows a structure which represents a combination of FIG. 5a and FIG. 5b. The conductive layer or structure 3, which is made of platinum, gold, nickel or a CrNi-alloy, for example, is embedded between two ADM layers 2 and 4. This structure contains the advantages of the insulation layer 2 and the covering or the passivation layer 4 and is used as a temperature resistor or heating resistor.

The following design examples show the advantages of the layers produced with ADM particularly well. The layers produced thus have a low porosity, are free of cracks and low in defects and have a very high density. A particularly proven material as an ADM layer is Al₂O₃, since these layers have a high electrical insulation resistance combined with good thermal conductivity. Depending on the application, layer thicknesses in the range of 0.5 to 50 μm are practical. Layer thicknesses of 5 to 10 μm have proven particularly successful.

FIG. 6a shows an extension of the structure of FIG. 5b. The ADM layer 5 covering the first conductive surface or structure 3 here is an insulation layer on which an additional conductive surface or structure 6 is applied. The insulation layer material consists of Al₂O₃, MgO or a mixture of the two materials. Al₂O₃ has proven particularly successful.

The conductive surface or structure 6 shown here is implemented as a resistance loop and represents a heater. The structure is used, for example, as a flow or mass flow sensor based on the anemometer principle, in which a conductive structure 3 is used as a temperature resistance and the other conductive structure 6 is used as a heating resistor. The property measured is the proportional heat loss.

FIG. 6b shows the extension of the sensor structure of FIG. 6a. In addition, the top layer is an ADM layer applied as a passivation layer 7 and protects the conductive surface or structure 6 underneath it against corrosive attack.

FIG. 6c shows a design variant of FIG. 6a, where in this case the upper conductive layer or structure 6 is implemented as a double electrode structure in the form of an IDE structure. This structure can be used as a conductivity sensor. The IDE structure is used to measure the resistance between the electrodes when it is immersed in a liquid or a gas stream. Deposits on the sensor surface can also be measured by resistive measurement.

FIG. 6d shows an extension of the sensor structure of FIG. 6c. In addition, the topmost layer is an ADM layer applied as an insulation or passivation layer 7. The sensor functions described in FIG. 6c can be evaluated by means of capacitive measurements or impedance measurements.

FIG. 7a shows a sensor design with three conductive surfaces or structures 3, 6 and 9 on a substrate carrier 1. The conductive surfaces or structures 3, 6 and 9 are at least one temperature resistance, one heating resistor and one electrode structure. The conductive surfaces or structures 3, 6 and 9 are electrically insulated from each other by at least one ADM layer 5, 8 in each case. This structure can be used as a conductivity sensor, wherein for the IDE structure for measuring the conductivity, at least one heating structure is used for temperature controlling the sensor. A resistance structure can be used for temperature measurement.

FIG. 7b shows a further embodiment of FIG. 7a, which as a top layer additionally contains an ADM layer as an insulation or passivation layer 10. With this structure a surface deposit on the top ADM layer 10 can be detected using a capacitive measurement or impedance measurement.

FIG. 7c shows an extension of the embodiment of FIG. 7a, with an additional layer 11 being applied above the IDE structure. This layer 11 is used as a functional layer, which changes the electrical properties in response to particular gases. This structure can be used as a gas sensor.

### LIST OF REFERENCE NUMERALS

1 substrate carrier
2 insulation layer (I) by (ADM)
3 conductive layer (I) or structure(s)
4 covering layer (I) by ADM
5 insulation layer (II) by (ADM)
6 conductive layer (II) or structure(s)
7 covering layer (II) by ADM
8 insulation layer (III) by (ADM)
9 conductive layer (III) or structure(s)
10 covering layer (III) by ADM
11 functional layer

1-18. (canceled)

19. A method for producing a temperature sensor comprising at least one electrically conductive layer and at least one additional layer, the at least one additional layer comprising at least one of a passivation layer and an insulation layer,
characterized in that the electrically conductive layer and/or the at least one additional layer is produced by aerosol deposition (aerosol deposition method, ADM).

20. The method of claim 19, further comprising:
a) providing a sensor carrier;
b) directly or indirectly applying the at least one electrically conductive layer on the sensor carrier; and
c) applying the at least one additional layer by aerosol deposition (ADM).

21. The method of claim 20, further comprising using, in the aerosol deposition in (c), a powder of:
a) aluminium oxide (Al₂O₃) with a purity of the base materials of at least 94 wt. % and/or
b) magnesium oxide (MgO) with a purity of the base materials of at least 94 wt. % and/or
c) magnesium titanate in the compositions Mg₂TiO₅, MgTiO₃, or MgTi₂O₅, with a total purity of the base materials of at least 98 wt. % and/or
d) binary zirconia alloys (ZrO₂) with the stabilizers yttrium oxide, in particular 0 wt. % to 20 wt. % yttrium oxide, and/or CaO, and in particular 0 wt. % to 15 wt. % CaO, and/or MgO, in particular 0 wt. % to 15 wt. % MgO, with a total purity of the base materials of at least 98 wt. % and/or
e) ternary alloys (zirconia ZrO₂) as specified in d) with further additives formed of Nb₂O₅, in particular 0 wt. % to 30 wt. % Nb₂O₅, and/or Ta₂O₅, in particular 0 wt.-% to 30 wt. % Ta₂O₅, with a total purity of the base materials of at least 98 wt. %.

22. The method of claim 21, further comprising using, in that in the aerosol deposition in (c), a powder with a purity of the base materials of at least 95%, wherein in particular the powder of aluminium oxide (Al₂O₃) and/or magnesium oxide (MgO) and/or zirconium oxide (zirconia (ZrO₂), which in particular is stabilized, is used with a purity of the base materials of at least 95% or any mixture thereof.

23. The method of claim 20, further comprising using, in the aerosol deposition, in (c), an inert gas comprising one of helium (He), argon (Ar), nitrogen (N₂), and oxygen (O₂) as the carrier gas, and a temperature treatment of not more than 150° C.

24. The method of claim 20, characterized in that the at least one electrically conductive coating is structured, or applied indirectly or directly on the sensor carrier in a structured form.

25. A temperature sensor, comprising:
at least one electrically conductive layer; and
at least one additional layer comprising one of a passivation layer and an insulation layer characterized in that the at least one additional layer is produced by aerosol deposition (aerosol deposition method, ADM).

26. The sensor of claim 25, characterized in that at least one layer produced using aerosol deposition comprises:
a) aluminium oxide (Al₂O₃) with a purity of the base materials of at least 94 wt. %
and/or
b) magnesium oxide (MgO) with a purity of the base materials of at least 94 wt. %
and/or
c) magnesium titanate in the compositions Mg₂TiO₅, MgTiO₃ or MgTi₂O₅ with a total purity of the base materials of at least 98 wt. %
and/or
d) binary zirconia alloys (ZrO₂) with the stabilizers yttrium oxide, in particular 0 wt. % to 20 wt. % yttrium oxide, and/or CaO, and in particular 0 wt. % to 15 wt. % CaO, and/or MgO, in particular 0 wt. % to 15 wt. % MgO, with a total purity of the base materials of at least 98 wt. %
and/or
e) ternary zirconia alloys (ZrO₂) as specified in d) with further additives formed of Nb₂O₅, in particular 0 wt. % to 30 wt. % Nb₂O₅, and/or Ta₂O₅, in particular 0 wt.-% to 30 wt. % Ta₂O₅, with a total purity of the base materials of at least 98 wt. %.

27. The sensor of claim 25, characterized in that at least one layer produced using aerosol deposition consists of at least 95% aluminium oxide (Al₂O₃).

28. The sensor of claim 27, characterized in that the specific electrical resistance of at least one Al₂O₃ layer produced by means of aerosol deposition at a temperature of 600° C. is at least 10¹⁰ Ohm cm.

29. The sensor of claim 25, characterized in that at least one layer produced by means of aerosol deposition has a thickness of 100 nm-50 μm.

30. The sensor of claim 25, characterized in that at least one layer produced by means of aerosol deposition (ADM) has a hardness of at least 6 Gpa.

31. The sensor of claim 25, characterized in that at least one layer produced by means of aerosol deposition (ADM) is moisture tight.

32. The sensor of claim 25, characterized by a sensor support, comprising:
a) aluminium oxide (Al₂O₃) with a purity of the base materials of at least 94 wt. %
and/or
b) magnesium oxide (MgO) with a purity of the base materials of at least 94 wt. % at least 94 wt. %
and/or
c) magnesium titanate in the compositions Mg₂TiO₅, MgTiO₃ or MgTi₂O₅ with a total purity of the base materials of at least 98 wt. %
and/or
d) binary zirconia alloys (ZrO₂) with the stabilizers yttrium oxide, in particular 0 wt. % to 20 wt. % yttrium oxide, and/or CaO, and in particular 0 wt. % to 15 wt. % CaO, and/or MgO, in particular 0 wt. % to 15 wt. % MgO, with a total purity of the base materials of at least 98 wt. % and/or
e) ternary zirconia alloys (ZrO₂) as specified in d) with further additives formed of Nb₂O₅, in particular 0 wt. % to 30 wt. % Nb₂O₅, and/or Ta₂O₅, in particular 0 wt.-% to 30 wt. % Ta₂O₅, with a total purity of the base materials of at least 98 wt. %.

33. The sensor of claim 25, characterized in that at least one electrically conductive coating preferably consists of metal, in particular of platinum (Pt) and/or rhodium (Rh) and/or iridium (Ir) and/or palladium (Pd) and/or gold (Au) and/or tungsten (W) and/or tantalum (Ta) and/or nickel (Ni) and/or copper (Cu) and/or of an alloy of the specified metals.

34. The sensor of claim 25, characterized by at least two electrically conductive layers, wherein between the at least two electrically conductive layers of at least one layer is produced by means of aerosol deposition.

35. The sensor of claim 25, characterized by at least two electrically conductive layers, wherein the electrically conductive layers are connected to each other via at least one measuring bridge.

36. The sensor of claim 25 used in a vehicle for measuring a temperature and/or particle quantities and/or soot particle quantities and/or reaction heat and/or a gas content and/or a gas flow.
